(19) United States
(12) Patent Application Publication
(10) Pub. No.: US 2020/0302460 A1
(43) Pub. Date: Sep. 24, 2020

(54) INFORMATION PROVIDING METHOD, INFORMATION PROVIDING PROGRAM, AND INFORMATION PROVIDING APPARATUS

(71) Applicant: FUJITSU LIMITED, Kawasaki-shi (JP)

(72) Inventors: Hiroaki Yamada, Kawasaki (JP); Kotaro Ohori, Chuo (JP)

(73) Assignee: FUJITSU LIMITED, Kawasaki-shi (JP)

(21) Appl. No.: 16/811,025

(22) Filed: Mar. 6, 2020

(30) Foreign Application Priority Data
Mar. 18, 2019 (JP) 2019-050325

(51) Int. Cl. G06Q 30/02; G06K 9/00

(52) U.S. Cl. CPC G06Q 30/0208; G06Q 30/0204; G06K 9/00778; G06Q 30/0224

(57) ABSTRACT

An information providing method executed by a computer, includes: based on respective pieces of attribute information of a plurality of moving subjects, grouping moving subjects estimated to have relationships to each other among the plurality of moving subjects; and for each group of the grouped moving subjects, providing, to each moving subject belonging to the group, information for influencing a destination of the moving subject.

### CROSS-REFERENCE TO RELATED APPLICATION

This application is based upon and claims the benefit of priority of the prior Japanese Patent Application No. 2019-50325, filed on Mar. 18, 2019, the entire contents of which are incorporated herein by reference.

### FIELD

The embodiments discussed herein are related to an information providing method, an information providing program, and an information providing apparatus.

### BACKGROUND

To ease congestion in facilities, such as airports and venues, people flow navigation that navigates moving subjects into an uncrowded facility by providing information, such as distributing coupons, is performed. In providing information regarding the people flow navigation, a technique of the related art uniformly provides information for navigating moving subjects into an uncrowded facility to the moving subjects to aim at smoothing congestion.

In some cases, uniformly providing information to moving subjects causes a macroscopic phenomenon that is not desirable, such as a vibration phenomenon (a hunting phenomenon) in which many people gather together according to information, such that a facility that has not been crowded is crowded, and conversely, a facility that has been crowded is not crowded. As a technique to reduce such a hunting phenomenon, there is a known technique that distributes information to some of the moving subjects to allocate the number of users of each facility so that the utility of the facility is the same for each of the users.

Examples of the related art include Japanese Laid-open Patent Publication No. 2008-310577 and Japanese Laid-open Patent Publication No. 2002-259251.

Examples of the related art also include Takashi Oguchi, Takayuki Satoh, Shigenori Shikata, “Providing Effects of Traffic Information on Alternative Route Choice Behavior in Congested Traffic Condition”, Infrastructure planning review, 2005, 22, p. 799-804, and BECKMANN, M. J., C. B. McGUIRE, AND C. B. WINSTEN (1956). Studies in the Economics of Transportation. Yale University Press, New Haven, Conn.

### SUMMARY

According to an aspect of the embodiments, an information providing method executed by a computer, includes: based on respective pieces of attribute information of a plurality of moving subjects, grouping moving subjects estimated to have relationships to each other among the plurality of moving subjects; and for each group of the grouped moving subjects, providing, to each moving subject belonging to the group, information for influencing a destination of the moving subject.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining an overview of provision of information according to an embodiment;

FIG. 2 is a block diagram illustrating an example of a functional configuration of an information providing apparatus according to an embodiment;

FIG. 3 is an explanatory diagram for explaining estimation of user selection;

FIG. 4 is a flowchart illustrating an example of operations of an information providing apparatus according to an embodiment;

FIGS. 5A and 5B are a flowchart illustrating an example of a process of grouping;

FIG. 6 is an explanatory diagram for explaining an example of selection of distribution recipients;

FIG. 7 is a flowchart illustrating a modification of operations of an information providing apparatus according to an embodiment;

FIG. 8 is a flowchart illustrating an example of a process of proximity determination;

FIG. 9 is an explanatory diagram for explaining an example of selection of distribution recipients;

FIG. 10 is an explanatory diagram for explaining a congestion state due to existing information provision;

FIG. 11 is an explanatory diagram for explaining a congestion state due to information provision in an embodiment; and

FIG. 12 is a block diagram illustrating an example of a hardware configuration of an information providing apparatus according to an embodiment.

### DESCRIPTION OF EMBODIMENT(S)

However, the existing related-art technique described above assumes that moving subjects move as indicated in the provided information, and therefore has a problem in that, in reality, moving subjects do not move as expected and thus an undesired macroscopic phenomenon, which is represented by a hunting phenomenon, may occur.

For example, moving subjects act as a group in some cases. Providing non-uniform information to respective ones of such moving subjects acting as a group (for example, information is provided to one member and is not provided to the other members) generates negative solidary incentives for dividing a group. The solidary incentives are rewards of companionship and comfortableness in a group, a sense of belonging thereto, and so on, and negative solidary incentives correspond to a dislike for division of a group. When negative solidary incentives are generated in such a manner, there are some cases where each moving subject will not move as indicated by the provided information in order to inhibit the group from being divided.

In one aspect, an object is to provide an information providing method, an information providing program, and an information providing apparatus that may suitably perform people flow navigation.

According to an embodiment of the present disclosure, people flow navigation may be suitably performed.

Hereinafter, with reference to the drawings, description is given of an information providing method, an information providing program, and an information providing apparatus according to an embodiment. In the embodiment, configurations having the same functions are denoted by the same reference signs, and the redundant description thereof is omitted. The information providing method, the information providing program, and the information providing apparatus described in an embodiment described bellow are merely illustrative and not intended to limit the embodiment. In addition, the following embodiments may be combined as appropriate to the extent that they are not inconsistent with each other.

[Overview of Provision of Information]

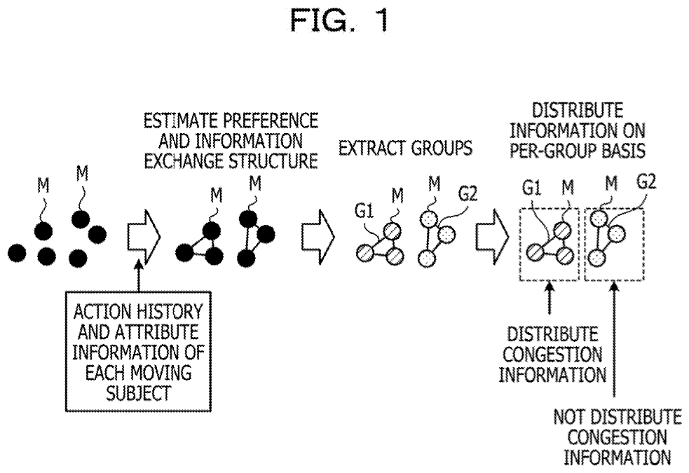

FIG. 1 is an explanatory diagram for explaining an overview of provision of information according to an embodiment. As illustrated in FIG. 1, provision of information according to an embodiment distributes congestion information indicating the congestion state of a facility, which is an example of information for influencing a destination, to moving subjects M to perform people flow navigation, for example, in order to ease congestion in facilities, such as airports and venues.

The moving subject M is a general term for units capable of autonomously determining a target facility (destination) to move to the facility (destination), and corresponds to one vehicle driven by a driver, one person, or the like. In the present embodiment, one user who purchased a ticket of an event venue including various facilities and was admitted to the event venue will be described as an example of the moving subject M.

In the present embodiment, first, the preference of each moving subject M for each facility and an information exchange structure among the moving subjects M are estimated from the action history (for example, a history of selecting facilities in a venue) and attribute information (for example, user attributes registered upon purchasing a ticket) of each moving subject M.

For example, for the preference of each moving subject M for each facility, the utility of each of facilities for each moving subject M is determined from the charm of each facility, which is determined from a selection history of facilities selected by each moving subject M, and the distance of the moving subject M to each facility. A facility determined to have the highest utility is estimated to be preferred by the moving subject M.

The information exchange structure among the moving subjects M indicates whether the exchange of information between each other is sparse or dense. For example, for the case where the moving subjects M are in proximity to each other (which not only simply means proximity in terms of distance but also includes social proximity, such as friends or a family) and are estimated to have relationships to each other, the information exchange structure is estimated as an information exchange structure in which the exchange of information between each other is dense. Conversely, for the case where the moving subjects M are not in proximity to each other, the information exchange structure is estimated as an information exchange structure in which the exchange of information between each other is sparse.

Subsequently, in the present embodiment, based on the estimated information exchange structure among the moving subjects M, groups are extracted, so that grouping is performed. For example, the moving subjects M that are estimated to have relationships to each other and that are estimated to have an information exchange structure in which the exchange of information between each other is dense are grouped as a group G1, a group G2, or the like. The moving subjects M that are not in proximity to each other and that are estimated to have an information exchange structure in which the exchange of information between each other is sparse are grouped as a group different from the group in which the exchange of information is dense.

Subsequently, in the present embodiment, information distribution is performed on a per-group basis after the moving subjects M have been grouped. By way of example, congestion information is to be distributed to each of the moving subjects M belonging to the group G1, and congestion information is not to be distributed to each of the moving subjects M belonging to the group G2.

In such a manner, in the present embodiment, the moving subjects M are collected into the groups G1 and G2 on a per-group basis, in which the moving subjects M have relationships to each other, and then information for influencing a destination (for example, congestion information) is distributed to the groups G1 and G2 on a per-group basis. Thus, uniform information is provided to the moving subjects M belonging to each of the groups G1 and G2 in which the moving subjects M are estimated to have relationships to each other and to act as a group.

Accordingly, people flow navigation using provision of information according to the present embodiment may suppress the occurrence of negative solidary incentives, which would divide the groups G1 and G2, and enables suitable people flow navigation to be performed as expected. Performing such people flow navigation as expected may suppress the occurrence of an undesired macroscopic phenomenon, which is represented by a hunting phenomenon.

[Functional Configuration and Operations of Information Providing Apparatus]

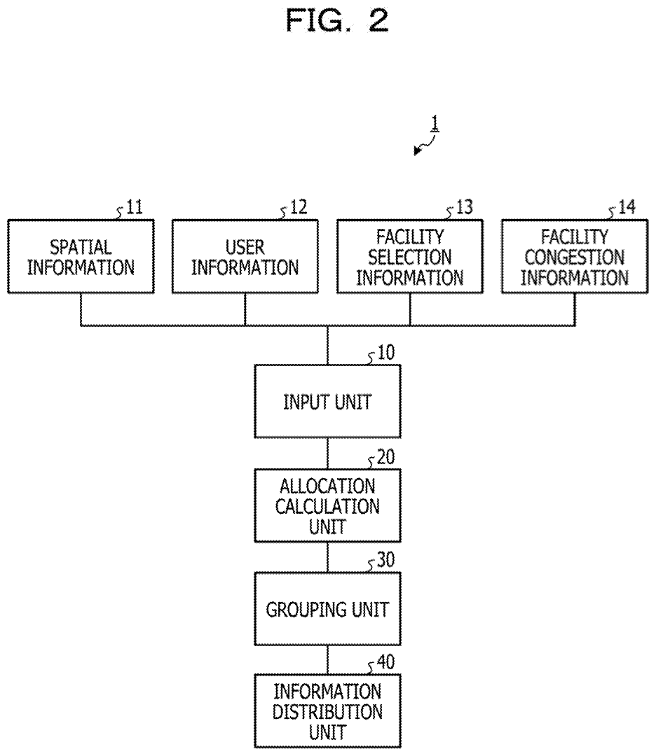

FIG. 2 is a block diagram illustrating an example of a functional configuration of an information providing apparatus according to an embodiment. An information processing device, such as a personal computer (PC), may be applied to an information providing apparatus 1 illustrated in FIG. 2. As illustrated in FIG. 2, the information providing apparatus 1 includes an input unit 10, an allocation calculation unit 20, a grouping unit 30, and an information distribution unit 40.

The input unit 10 is a processing unit that receives input of various types of information about provision of information, such as spatial information 11, user information 12, facility selection information 13, and facility congestion information 14.

The spatial information 11 is information about the space (the area, the number of floors, walls, passages, the facility location, and so on) in an event venue, such as positional information of each facility that may become a destination of the moving subjects M.

The user information 12 is information of each user of an event venue, that is, each moving subject M. For example, the user information 12 includes various types of information about the moving subject M for each piece of identification information that identifies the moving subject M, such as a ticket number given to a ticket of an event venue.

Examples of the information about the moving subject M in the user information 12 include attribute information indicating the attributes of the moving subject M, positional information indicating the current position of the moving subject M obtained by using the Global Positioning System (GPS) and the like, and address information (for example, an email address, a social network service (SNS) account, and the like) that is to be notified of information for the moving subject M, and so on.

Examples of the attribute information of the moving subject M include the age of the moving subject M, the family structure, the group structure, the ticket type associated with the structure, and so on. Regarding the attribute information of the moving subject M, for example, the content entered from an input screen at the time of pre-booking of a ticket is stored.

An action history of the moving subject M may be included in the attribute information of the moving subject M. Examples of the action history of the moving subject M include the content of an action upon purchasing a ticket (including, for example, whether the ticket was purchased through pre-booking, and whether there was a simultaneous purchaser), the date and time of purchase of a ticket, the date and time of entry to an event venue, and so on.

The facility selection information 13 is history information of facilities selected and visited by each of the moving subjects M. For example, in the facility selection information 13, the history of facilities visited by each moving subject M is indicated based on ticket numbers read from tickets possessed by the moving subject M at facilities selected as destinations and visited by the moving subject M. For example, the facility selection information 13 is an example of history information of destinations of each of the moving subjects M.

The facility congestion information 14 is information indicating congestion information of each facility that may become a destination of the moving subjects M, for example, the number of persons in a wait queue counted for each facility.

The allocation calculation unit 20 is a processing unit that calculates the allocated quantity of users (the moving subjects M) assigned to each facility that may become a destination of the moving subjects M.

For example, the allocation calculation unit 20 estimates the preference of the moving subject M for each facility (destination) by using the known maximum likelihood method, based on previous selection actions (which facility was selected and visited) of the moving subject M indicated in the facility selection information 13, and the facility congestion information 14.

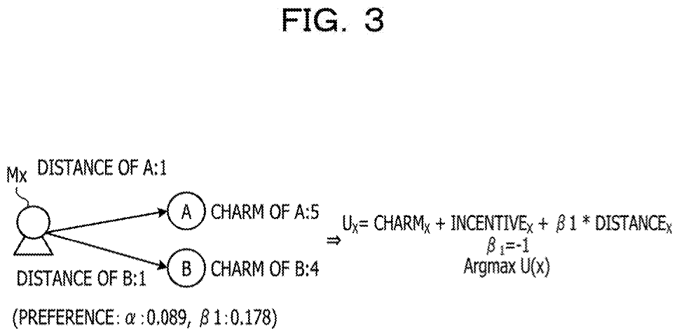

FIG. 3 is an explanatory diagram for explaining estimation of user selection. In FIG. 3, the case of estimating the preferences of a moving subject Mx for facilities A and B is illustrated. By comparing the positional information of the moving subject Mx in the user information 12 with the positional information of the facilities A and B in the spatial information 11, the allocation calculation unit 20 determines that the distances of the facilities A and B to the moving subject Mx are each “one”.

The allocation calculation unit 20 also determines the respective charms of the facilities A and B for the moving subject Mx from the previous selection actions (for example, the number of selections of facilities of the same type as the facility A or the facility B) of the moving subject Mx indicated by the facility selection information 13 and the congestion state (the number of persons in a wait queue) of each facility indicated by the facility congestion information 14. For example, in accordance with the number of selections of facilities of the same type as the facility A or the facility B in the previous selection actions, the allocation calculation unit 20 regards the facility A or the facility B as having great charm if the number of selections is large. Additionally, in accordance with the number of persons in a wait queue of each facility, the allocation calculation unit 20 regards the facility as having great charm if the number of persons in the wait queue is small. Thus, the allocation calculation unit 20 ranks the charm of the facility A for the moving subject Mx as “5” and the charm of the facility B as “4”.

As illustrated in FIG. 3, the allocation calculation unit 20 determines utilities (Ux) based on the charms of the facilities A and B for the moving subject Mx, the distances to the facilities A and B, and the like. Subsequently, the allocation calculation unit 20 estimates a facility with the highest utility (Ux) as the one preferred by the moving subject Mx.

Subsequently, based on the obtained preferences of the moving subjects M, the allocation calculation unit 20 calculates the allocated quantity of each facility with which the utility of each facility is the same for users (moving subjects M), that is, with which user equilibrium (Wardrop equilibrium) is achieved. For example, the allocation calculation unit 20 calculates equilibrium allocations, with which the utility of each facility is the same for users (moving subjects M), by using the known Frank-Wolfe method.

By providing information for influencing a destination (for example, congestion information) to the moving subject M with an allocated quantity calculated by the allocation calculation unit 20, people flow navigation that is suitable to achieve user equilibrium (in which the respective utilities of facilities for users are balanced) may be performed.

The grouping unit 30 is a processing unit that, based on the user information 12 of each moving subject M, groups the moving subjects M that are estimated to have relationships to each other.

The information distribution unit 40 is a processing unit that, for each group of the moving subjects grouped by the grouping unit 30, provides, to each moving subject M belonging to the group, information (for example, congestion information) for influencing a destination of the moving subject M.

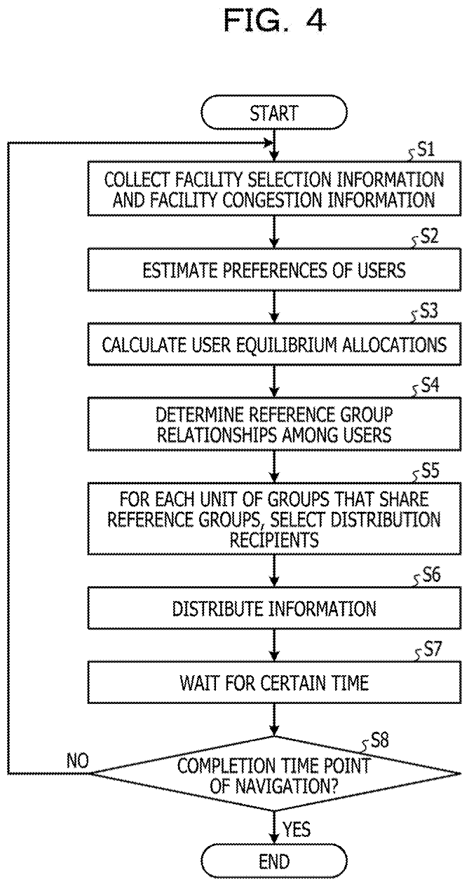

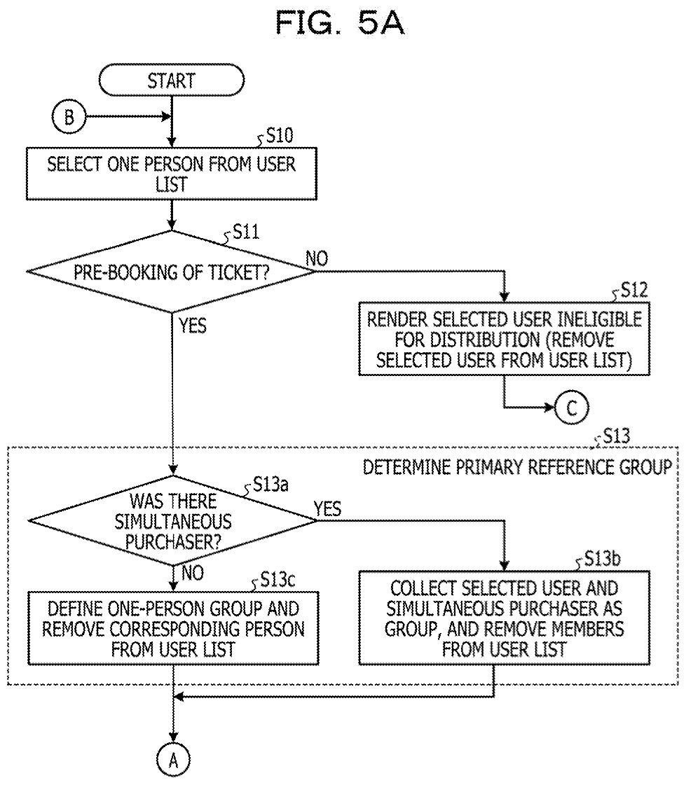

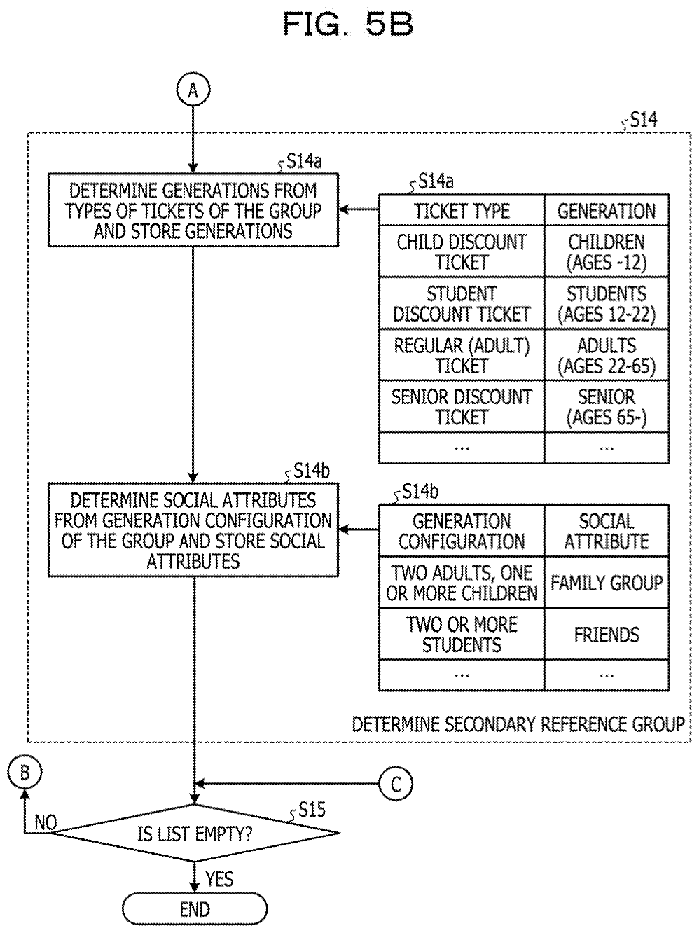

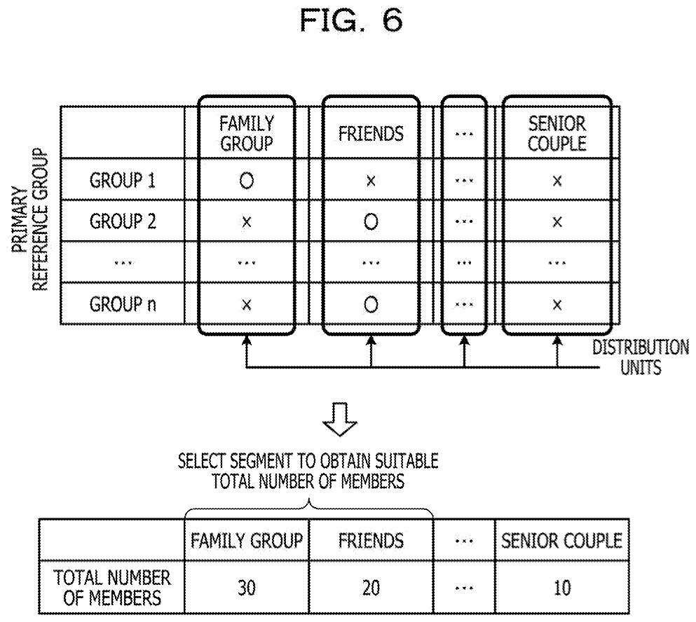

With reference to FIG. 4 to FIG. 6, the details of processing in the grouping unit 30 and the information distribution unit 40 will be described. FIG. 4 is a flowchart illustrating an example of operations of the information providing apparatus 1 according to the embodiment. FIG. 5 is a flowchart illustrating an example of a process of grouping. FIG. 6 is an explanatory diagram for explaining an example of selection of distribution recipients.

As illustrated in FIG. 4, as the process begins, the allocation calculation unit 20 collects the facility selection information 13 and the facility congestion information 14 input by the input unit 10 (S1).

Subsequently, the allocation calculation unit 20 estimates the preferences of the moving subjects M for each facility (destination) based on previous selection actions of the moving subjects M indicated in the facility selection information 13, and the facility congestion information 14 (S2).

Subsequently, based on the estimated preferences of the moving subjects M, the allocation calculation unit 20 calculates the allocated quantity of each facility with which user equilibrium (Wardrop equilibrium) is achieved (S3).

Subsequently, the grouping unit 30 creates a user list of users (moving subjects M) who have entered an event venue, based on the user information 12 of each moving subject M, and determines reference group relationships among users (moving subjects M) included in the user list (S4). Based on a determination result of reference group relationships, the grouping unit 30 performs grouping such that groups that share the reference groups constitute a unit.

For example, as illustrated in FIG. 5 (i.e., FIGS. 5A and 5B), as the process of grouping begins, the grouping unit 30 arbitrarily selects one person from the user list (S10). Subsequently, for the selected user (moving subject M), the grouping unit 30 determines, based on an action history (content of actions performed upon purchasing a ticket) included in the user information 12, whether there was pre-booking of a ticket (S11).

If there was not pre-booking of a ticket (S11: NO), the grouping unit 30 does not know whether there was simultaneous purchase of tickets, and therefore renders the selected user (moving subject M) ineligible for distribution. Subsequently, the grouping unit 30 removes the selected user (moving subject M) from the user list (512), and causes the process to proceed to S15.

If there was pre-booking of a ticket (S11: YES), the grouping unit 30 makes determinations of a primary reference group and a secondary reference group for the selected user (moving subject M) based on the user information 12 (S13, S14).

For example, based on an action history included in the user information 12, the grouping unit 30 determines whether there was a simultaneous purchaser (S13a). If there was a simultaneous purchaser (S13a: YES), the grouping unit 30 collects, as a group, the selected user (moving subject M) and the simultaneous purchaser, and removes the members of the group from the user list (S13b).

If there was no simultaneous purchaser (S13a: NO), the grouping unit 30 defines the selected user (moving subject M) as a one-person group and removes the corresponding person from the user list (S13c).

In such a manner, in S13, the grouping unit 30 determines the relationship of the primary reference group for the selected user (moving subject M), that is, the grouping unit 30 determines, from persons who simultaneously purchased tickets, whether there is a friend or family relationship (which is highly likely to be a friend group or a family group).

Subsequently, for the group determined regarding the primary reference group in S13, the grouping unit 30 determines the generations of the members from the types of tickets of the group and stores the determined generations in a memory or the like (S14a). For example, the grouping unit 30 checks the types of tickets indicated in the user information 12 against a generation determination table T1 set in advance and determines the generations (children, students, adults, senior citizens, or the like).

Subsequently, for the group determined regarding the primary reference group in S13, the grouping unit 30 determines the social attributes of the group from the generation configuration of the group and stores the determined social attributes in a memory or the like (S14b). For example, the grouping unit 30 checks the configuration of generations determined in S14a against a social-attribute determination table T2 set in advance and determines the social attributes (family group, friends, or the like).

In such a manner, in S14, the grouping unit 30 further determines the relationship of the secondary reference group (generations and social attributes) for the group that has been determined regarding the primary reference group.

Subsequently, the grouping unit 30 determines whether the user list is empty (S15) and, if not (S15: NO), causes the process to return to S20. If the user list is empty (S15: YES), the process terminates.

Referring back to FIG. 4, subsequently to S4, for each unit of groups that share reference groups, the information distribution unit 40 selects distribution recipients of information so as to meet the allocated quantity of each facility calculated in S3 (S5).

FIG. 6 is an explanatory diagram for explaining an example of selection of distribution recipients. As illustrated in FIG. 6, the information distribution unit 40 defines, as a distribution unit, groups sharing reference groups, which are determined by grouping of the grouping unit 30. The information distribution unit 40 determines the total number of members of the groups.

For example, since “group 1” and so on fall under the group “family group”, the total number of members of “group 1”, 30, is obtained. Since “group 2”, “group n” and so on fall under the group “friends”, the total number of members of “group 2” and “group n”, 20, is obtained.

Subsequently, the information distribution unit 40 selects a segment (a combination of groups) to obtain a suitable total number of members so that the allocated quantity of each facility calculated in S3 is met. For example, in the case where the allocated quantity is 50, the total number of members of “family group” and “friends”, which is 30+20, is closest to 50. Accordingly, the information distribution unit 40 defines the groups of “family group” and “friends” as a distribution unit and selects the moving subjects M in the groups as distribution recipients.

Referring back to FIG. 4, subsequently to S5, the information distribution unit 40 distributes information for influencing a destination (for example, congestion information, information for offering an incentive such as time service information, and the like) to the selected distribution recipients (moving subjects M). For example, the information distribution unit 40 references address information of the user information 12 and provides information to the addresses of the selected distribution recipients (moving subjects M).

In provision of information of the information distribution unit 40, for example, information randomly selected among information set in advance is provided so as to inhibit a question about the reason for selecting a segment from being asked (so as to avoid a sense of unfairness in providing information to some of groups).

Subsequently, the information distribution unit 40 waits for processing for a certain time period (S7) and determines whether the completion time point of navigation, which is set in advance, is reached (S8). If the completion time point has not been reached (S8: NO), the information distribution unit 40 returns the process to S1. If the completion time point is reached (S8: YES), the information distribution unit 40 terminates the process.

The grouping unit 30 may determine social or distance proximity between users (moving subjects M) to perform grouping.

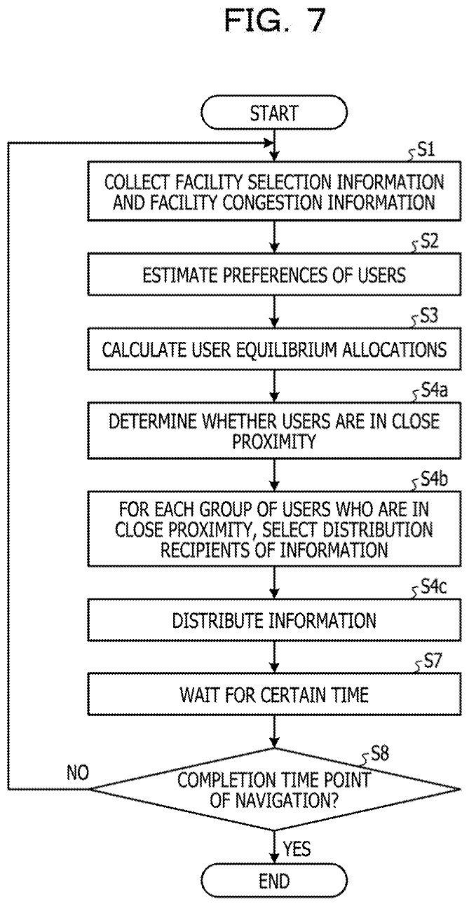

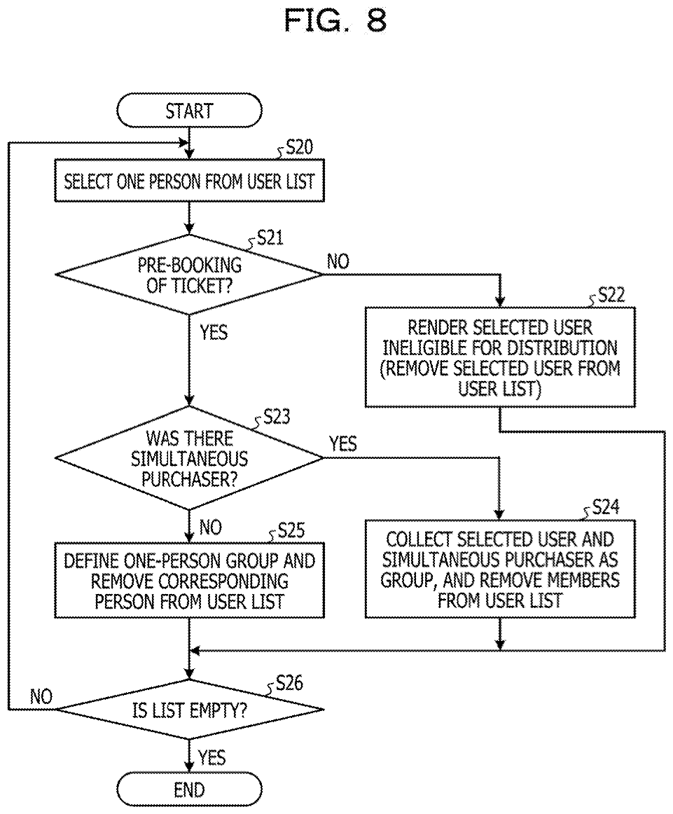

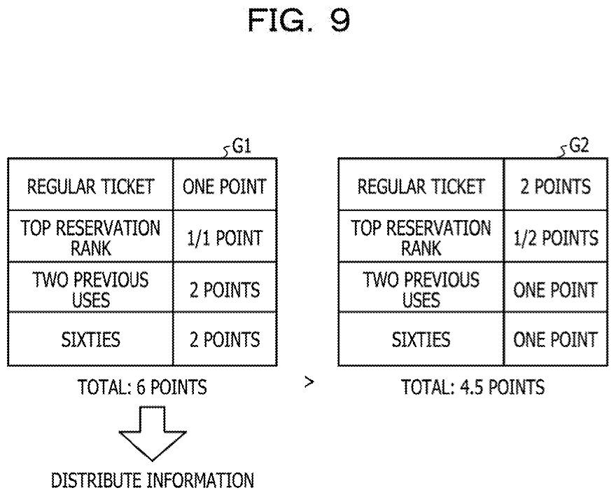

With reference to FIG. 7 to FIG. 9, the process of a modification of determining social or distance proximity between users (the moving subjects M) to perform grouping will be described in detail. FIG. 7 is a flowchart illustrating a modification of operations of the information providing apparatus 1 according to the embodiment. FIG. 8 is a flowchart illustrating an example of a process of proximity determination. FIG. 9 is an explanatory diagram for explaining an example of selection of distribution recipients.

As illustrated in FIG. 7, in the modification, the process content is the same as illustrated in FIG. 4, except that S4 to 56 described above are replaced with S4a to S4c. Therefore, description of the same process content is omitted and description of different process content is given.

As illustrated in FIG. 7, subsequently to S3, the grouping unit 30 creates a user list of users (moving subjects M) who have entered an event venue, based on the user information 12 of each moving subject M, and determines whether the users included in the user list are in close proximity (S4a). Based on a determination result in S4a, the grouping unit 30 performs grouping for each group of users who are in close proximity.

For example, as illustrated in FIG. 8, as the process of proximity determination begins, the grouping unit 30 arbitrarily selects one user from the user list (S20). Subsequently, for the selected user (moving subject M), the grouping unit 30 determines, based on an action history (the content of actions performed upon purchasing a ticket) included in the user information 12, whether there was pre-booking of a ticket (S21).

If there was not pre-booking of a ticket (S21: NO), the grouping unit 30 does not know whether there was simultaneous purchase of tickets, and therefore renders the selected user (moving subject M) ineligible for distribution. Subsequently, the grouping unit 30 removes the selected user (moving subject M) from the user list (522), and causes the process to proceed to S26.

If there was pre-booking of a ticket (S21: YES), for the selected user (moving subject M), the grouping unit 30 determines, based on an action history included in the user information 12, whether there was a simultaneous purchaser (S23). If there was a simultaneous purchaser (S23: YES), the grouping unit 30 collects, as a group, the selected user (moving subject M) and the simultaneous purchaser, and removes the members of the group from the user list (S24).

If there was not a simultaneous purchaser (S23: NO), the grouping unit 30 defines the selected user (moving subject M) as a one-person group and removes the corresponding person from the user list (S25).

Subsequently, the grouping unit 30 determines whether the user list is empty (S26) and, if not (S26: NO), causes the process to return to S20. If the user list is empty (S26: YES), the process terminates.

In such a manner, the grouping unit 30 may perform grouping by utilizing the facts that simultaneous purchase of tickets is highly likely to be made by friends, family members, or the like and that the friends or the family members are in close social proximity.

The proximity determination is not limited to depending on a simultaneous purchaser, but may be made based on another attribute information or action history. For example, in S23, based on an action history of the user information 12, it may be determined whether there was a person who entered a facility simultaneously with the selected user (moving subject M), and if so, the person is highly likely to be a friend or a family member of the selected user (moving subject M) and it may be determined that the person and the selected user (moving subject M) are in close proximity. In addition, in S23, based on the positional information of the moving subjects M in the user information 12, it may be determined whether the distance between the moving subjects M is less than or equal to a threshold, and if the distance is close, the moving subjects M are highly likely to be friends or family members and it may be determined that the moving subjects M are in close proximity.

Referring back to FIG. 7, subsequently to S4a, for each group of users who are in close proximity, the information distribution unit 40 selects distribution recipients of information so as to meet the allocated quantity of each facility calculated in S3 (S4b), and distributes information to the selected distribution recipients (S4c).

FIG. 9 is an explanatory diagram for explaining an example of selection of distribution recipients. As illustrated in FIG. 9, the information distribution unit 40 may score each of the groups G1 and G2 according to whether a predetermined condition is satisfied, and may prioritize the groups according to the scores. The information distribution unit 40 then may select distribution recipients so as to meet the allocated quantity, in the order beginning with a group having the highest score.

For example, in the example of FIG. 9, scores are assigned to the groups G1 and G1 according to whether the ticket is a regular ticket or a priority ticket (a priority ticket>a regular ticket). In addition, scores are assigned according to the order in which reservations are made (the earlier the reservation, the higher the priority). Scores are also assigned according to previous use results (the larger the number of times a group uses the facility, the higher priority the group has). Scores are also assigned according to the user attributes (a user with children or a senior citizen has a higher priority). Thus, since the group G1 has a score of 6 and the group G2 has a score of 4.5, in S4c, information is distributed to the moving subjects M of the group G1 with a higher score.

[With Respect to Effects]

As described above, the information providing apparatus 1 includes the grouping unit 30 and the information distribution unit 40. Based on respective pieces of attribute information of a plurality of moving subjects M, the grouping unit 30 groups the moving subjects M estimated to have relationships to each other among the plurality of moving subjects M. For each group of the grouped moving subjects M, the information distribution unit 40 provides, to each of the moving subjects M belonging to the group, information for influencing a destination of the moving subject M. In such a manner, for each of the groups G1 and G2, in which the moving subjects M have relationships to each other, the information providing apparatus 1 provides information, such as congestion information, to each of the moving subjects M belonging to each group. Therefore, provision of information of the information providing apparatus 1 may suppress the occurrence of negative solidary incentives, which would divide the groups G1 and G2, and enables suitable people flow navigation to be performed as expected.

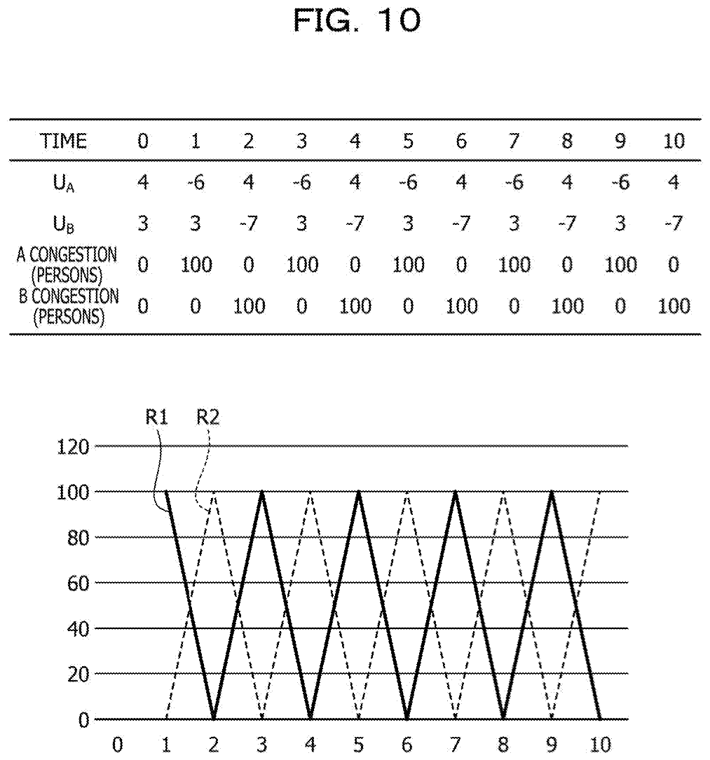

FIG. 10 is an explanatory diagram for explaining a congestion state due to existing information provision. As illustrated in FIG. 10, in existing information provision in which uniform information distribution is performed, as apparent from a result graph R1 representing changes in the number of persons in the crowd of the facility A and a result graph R2 representing changes in the number of persons in the crowd of the facility B, a vibration phenomenon with a large vibration range (0 to 100 persons in the illustrated example) has occurred.

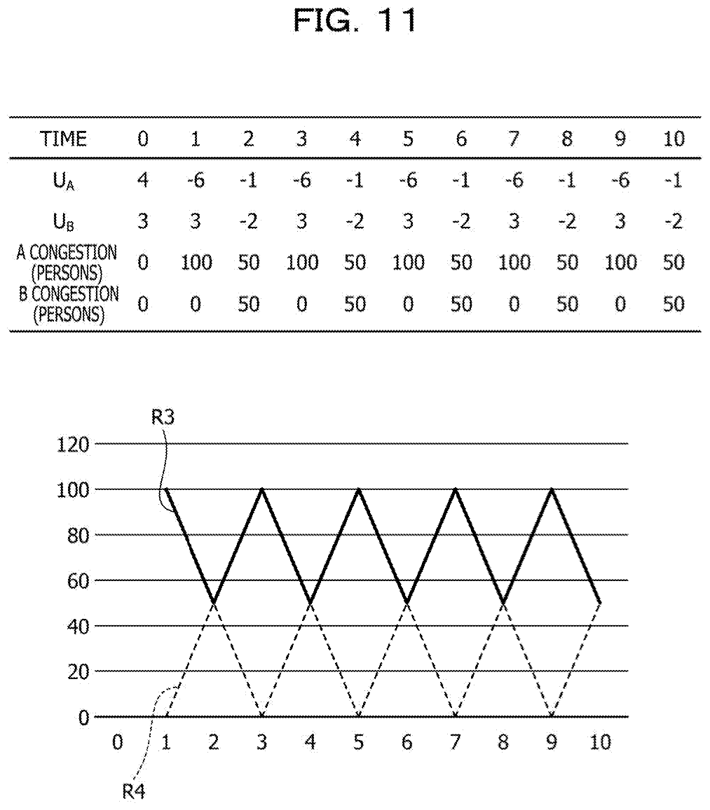

FIG. 11 is an explanatory diagram for explaining a congestion state due to information provision in an embodiment. In the example of FIG. 11, it is assumed that the values of preference are α: 0.089 and β1: 0.178 (the same as in FIG. 3) and that uniform assignment (A:B=50:50) is given. The same information is assumed to be provided to each of the moving subjects M that share reference groups (that are grouped).

As illustrated in FIG. 11, in information provision according to the present embodiment, as apparent from a result graph R3 representing changes in the number of persons in the crowd of the facility A and a result graph R4 representing changes in the number of persons in the crowd of the facility B, the vibration range of the congestion state is reduced (0 to 50 persons, 50 to 100 persons in the illustrated example).

The grouping unit 30 estimates, based on action histories of the moving subjects M included in the attribute information of the moving subjects M, whether the moving subjects M have relationships to each other, and performs grouping. In such a manner, the information providing apparatus 1 may estimate, from the action histories of the moving subjects M, whether the moving subjects M have relationships to each other.

The grouping unit 30 determines, based on the attribute information of the moving subjects M, whether the moving subjects M are in proximity to each other, and groups the moving subjects M that are in proximity to each other. The moving subjects M in proximity to each other readily exchange information and therefore are grouped so that common information is distributed to the moving subjects M. In such a manner, the information providing apparatus 1 groups the moving subjects M that are in proximity to each other so as to inhibit different pieces of information from being distributed in the group, which may inhibit the loss of reliability of information even when information exchange is performed.

The information providing apparatus 1 further includes the allocation calculation unit 20 that determines an allocated quantity of the moving subjects M for each of the destinations, based on preference for the destinations of each of the moving subjects M based on history information of the destinations of each of the moving subjects M. Based on the allocated quantity determined for each of the destinations, the information distribution unit 40 selects a group to which the information for influencing the destination is to be provided, and provides the information to each moving subject M belonging to the selected group. Thus, the information providing apparatus 1 may perform people flow navigation that is suitable to achieve, for example, user equilibrium (in which the respective utilities of facilities for a user are balanced).

[Others]

The processing procedure, the control procedure, specific names, and information including various types of data and parameters indicated in the foregoing embodiment may be changed arbitrarily. The specific examples, distributions, numerical values, and the like described in the foregoing embodiment are merely exemplary and may be changed arbitrarily.

The constituent elements of the apparatuses illustrated in the drawings are functionally conceptual ones and do not necessarily have to be physically configured as illustrated in the drawings. For example, specific forms of distribution and integration of the apparatuses are not limited to those illustrated in the drawings. Specific forms of the distribution and integration of the apparatuses are not limited to those illustrated in the drawings, and all or some of the apparatuses may be functionally or physically distributed and integrated in arbitrary units based on various loads, usage statuses, and the like. All or any part of the processing functions performed by the processing units may be implemented by a central processing unit (CPU) and a program to be analyzed and executed by the CPU, or may be implemented as hardware using wired logic.

All or any part of the various processing functions to be executed by the information providing apparatus 1 may be executed by the CPU (or a microcomputer such as a microprocessor unit (MPU) or a microcontroller unit (MCU)). It is to be understood that all or any part of the various processing functions may be executed by a program analyzed and executed by a CPU (or a microcomputer such as an MPU or an MCU) or may be executed by hardware using wired logic. In addition, the various processing functions to be executed by the information providing apparatus 1 may be executed by cloud computing in which a plurality of computers cooperate with each other.

[With Respect to Hardware Configuration]

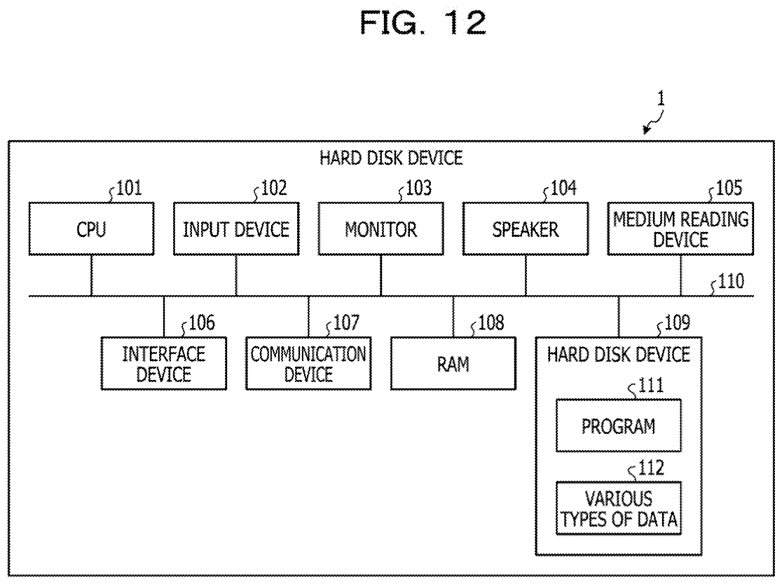

The various processes described in the foregoing embodiment may be realized by causing a computer to execute a program prepared in advance. An example of a computer (hardware) that executes a program with the same functions as those of the foregoing embodiment will be described below. FIG. 12 is a block diagram illustrating an example of a hardware configuration of the information providing apparatus 1 according to the embodiment.

As illustrated in FIG. 12, the information providing apparatus 1 includes a CPU 101 that executes various types of arithmetic processing, an input device 102 that receives input data, a monitor 103, and a speaker 104. The information providing apparatus 1 also includes a medium reading device 105 that reads a program and the like from a storage medium, an interface device 106 for coupling to various devices, and a communication device 107 for communicatively coupling to an external device in a wired or wireless way. The information providing apparatus 1 also includes a random-access memory (RAM) 108 that temporarily stores various types of information, and a hard disk device 109. The units (101 to 109) in the information providing apparatus 1 are coupled to a bus 110.

In the hard disk device 109, a program 111 for executing various processes is stored, which are relevant to the input unit 10, the allocation calculation unit 20, the grouping unit 30, and the information distribution unit 40 described in the foregoing embodiment. In the hard disk device 109, various types of data 112 referenced by the program 111 are also stored. The input device 102, for example, receives operation information input from an operator of the information providing apparatus 1. The monitor 103, for example, displays various screens to be operated by the operator. The interface device 106 is coupled to, for example, a printing device or the like. The communication device 107 is coupled to a communication network, such as a local area network (LAN), and exchanges various types of information with an external device via the communication network.

The CPU 101 reads the program 111 stored in the hard disk device 109 and loads and executes the read program 111 in the RAM 108, thereby executing various processes relevant to the input unit 10, the allocation calculation unit 20, the grouping unit 30, and the information distribution unit 40. The program 111 may not be stored in the hard disk device 109. For example, the program 111 stored in a storage medium readable by the information providing apparatus 1 may be read and executed by the information providing apparatus 1. The recording medium readable by the information providing apparatus 1 corresponds to a portable recording medium such as a compact disc (CD)-ROM, a digital versatile disc (DVD), or a Universal Serial Bus (USB) memory, a semiconductor memory such as a flash memory, a hard disk drive, or the like. The program 111 may be stored in a device coupled to a public line, the internet, a LAN, or the like, and the information providing apparatus 1 may read the program 111 from the device and execute the program 111.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information providing method executed by a computer, comprising:
based on respective pieces of attribute information of a plurality of moving subjects, grouping moving subjects estimated to have relationships to each other among the plurality of moving subjects; and
for each group of the grouped moving subjects, providing, to each moving subject belonging to the group, information for influencing a destination of the moving subject.

2. The information providing method according to claim 1, wherein
the grouping estimates, based on action histories of the moving subjects included in the attribute information, whether the moving subjects have relationships to each other, and performs grouping.

3. The information providing method according to claim 1, wherein
the grouping determines, based on the attribute information, whether the moving subjects are in proximity to each other, and groups the moving subjects that are in proximity to each other.

4. The information providing method according to claim 1, wherein
the computer further executes determining an allocated quantity of the moving subjects for each of the destinations, based on preference for the destinations of each of the moving subjects based on history information of the destinations of each of the moving subjects, and
based on the allocated quantity determined for each of the destinations, the providing selects a group to which the information for influencing the destination is to be provided, and provides the information to each moving subject belonging to the selected group.

5. An information providing program for causing a computer to execute a process, the process comprising:
based on respective pieces of attribute information of a plurality of moving subjects, grouping moving subjects estimated to have relationships to each other among the plurality of moving subjects; and
for each group of the grouped moving subjects, providing, to each moving subject belonging to the group, information for influencing a destination of the moving subject.

6. An information providing apparatus comprising:
a grouping unit that, based on respective pieces of attribute information of a plurality of moving subjects, groups moving subjects estimated to have relationships to each other among the plurality of moving subjects; and
an information distribution unit that, for each group of the grouped moving subjects, provides, to each moving subject belonging to the group, information for influencing a destination of the moving subject.
